(19) United States
(12) Patent Application Publication
(10) Pub. No.: US 2021/0279322 A1
(43) Pub. Date: Sep. 9, 2021

(54) ELECTRONIC DEVICE AND METHOD OF CONTROLLING THE SAME

(71) Applicant: Samsung Electronics Co., Ltd., Suwon-si (KR)

(72) Inventors: Mykola ALIEKSIEIEV, Suwon-si (KR); Oleksandr CHALYI, Suwon-si (KR); Oleksii PISKUN, Suwon-si (KR); Pavlo MURATOV, Suwon-si (KR); Serhii TVERDOKHLIB, Suwon-si (KR); Borys TKACHENKO, Suwon-si (KR)

(21) Appl. No.: 16/987,923

(22) Filed: Aug. 7, 2020

(30) Foreign Application Priority Data
Mar. 6, 2020 (KR) 10-2020-0028672

(51) Int. Cl. G06F 21/36; G06F 21/62; G06F 21/84

(52) U.S. Cl. CPC G06F 21/36; G06F 21/84; G06F 21/6245

(57) ABSTRACT

An electronic device is provided. The electronic device includes an input/output interface, and one or more processors configured to output a user authentication information restriction through the input/output interface, determine user input characteristics, based on user authentication information input based on the user authentication information restriction, and output, through the input/output interface, the user authentication information restriction updated based on the determined user input characteristics.

### CROSS-REFERENCE TO RELATED APPLICATION(S)

This application is based on and claims priority under 35 U.S.C. § 119(a) of a Korean patent application number 10-2020-0028672, filed on Mar. 6, 2020, in the Korean Intellectual Property Office, the disclosure of which is incorporated by reference herein in its entirety.

### BACKGROUND

### 1. Field

The disclosure relates to an electronic device. More particularly, the disclosure relates to an electronic device for receiving user authentication information or password information, and a method of controlling the electronic device.

### 2. Description of Related Art

Various existing user-authentication-based services or systems require a certain or higher level of user authentication information for enhanced security. However, users have difficulties in generating and memorizing user authentication information satisfying a certain criterion. In a user authentication scheme such as a pattern input, consistent user authentication information may not be easily input in a process of registering user cryptography information. Therefore, the accuracy and success rate of authentication are reduced.

The above information is presented as background information only, and to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages, and to provide at least the advantages described below. Accordingly, an aspect of the disclosure is to provide an electronic device capable of receiving a consistent user input by changing required user authentication information to a easily memorable and simple form by updating a user authentication information restriction based on user input characteristics, and a method of controlling the electronic device.

Another aspect of the disclosure is to provide an electronic device capable of enhancing security by registering input user authentication information and user input characteristics as user cryptography information and performing user authentication, and a method of controlling the electronic device.

Additional aspects will be set forth in part in the description which follows and, in part, will be apparent from the description, or may be learned by practice of the presented embodiments of the disclosure.

In accordance with an aspect of the disclosure, an electronic device is provided. The electronic device includes an input/output interface, and one or more processors configured to output a user authentication information restriction through the input/output interface, determine user input characteristics, based on user authentication information input based on the user authentication information restriction, and output, through the input/output interface, the user authentication information restriction updated based on the determined user input characteristics.

In accordance with another aspect of the disclosure, the one or more processors may be further configured to perform user authentication, based on the input user authentication information and the user input characteristics.

In accordance with another aspect of the disclosure, the one or more processors may be further configured to output a guide related to the user authentication information restriction, through the input/output interface based on user history information related to the user authentication information restriction.

In accordance with another aspect of the disclosure, the outputting of the user authentication information restriction through the input/output interface may include outputting at least one no-touch zone.

In accordance with another aspect of the disclosure, the electronic device may further include a sensor configured to obtain status or ambient environment information of the electronic device, and the user input characteristics may include at least one of processing unit information of the input user authentication information, difference information between the input user authentication information and the user authentication information restriction, or the status or ambient environment information of the electronic device maintained by a user while the user authentication information is being input.

In accordance with another aspect of the disclosure, the determining of the user input characteristics may include determining the user input characteristics through comparison with user history information related to the user input characteristics to the electronic device.

In accordance with another aspect of the disclosure, the user authentication information restriction may include a plurality of restrictions, and the user authentication information restriction updated based on the determined user input characteristics may include at least one restriction updated from among the plurality of restrictions.

In accordance with another aspect of the disclosure, the user authentication information restriction updated based on the determined user input characteristics may include the at least one no-touch zone, a location of which is changed and updated based on the determined user input characteristics.

In accordance with another aspect of the disclosure, a method of controlling an electronic device is provided. The method includes outputting a user authentication information restriction through an input/output interface, determining user input characteristics, based on user authentication information input based on the user authentication information restriction, and outputting, through the input/output interface, the user authentication information restriction updated based on the determined user input characteristics.

In accordance with another aspect of the disclosure, the method may further include performing user authentication, based on the input user authentication information and the user input characteristics.

In accordance with another aspect of the disclosure, the outputting of the user authentication information restriction through the input/output interface may include outputting a guide related to the user authentication information restriction, through the input/output interface based on user history information related to the user authentication information restriction.

In accordance with another aspect of the disclosure, the outputting of the user authentication information restriction through the input/output interface may include outputting at least one no-touch zone.

In accordance with another aspect of the disclosure, the user input characteristics may include at least one of processing unit information of the input user authentication information, difference information between the input user authentication information and the user authentication information restriction, or status or ambient environment information of the electronic device maintained by a user while the user authentication information is being input.

In accordance with another aspect of the disclosure, the determining of the user input characteristics may include determining the user input characteristics through comparison with user history information related to the user input characteristics to the electronic device.

In accordance with another aspect of the disclosure, the user authentication information restriction may include a plurality of restrictions, and the user authentication information restriction updated based on the determined user input characteristics may include at least one restriction updated from among the plurality of restrictions.

In accordance with another aspect of the disclosure, the user authentication information restriction updated based on the determined user input characteristics may include the at least one no-touch zone, a location of which is changed and updated based on the determined user input characteristics.

In accordance with another aspect of the disclosure, a computer program product is provided. The computer program product includes a recording medium having stored therein a program for executing the method.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram of an electronic device, according to an embodiment of the disclosure;

FIG. 2 is a diagram for describing examples of user authentication information or password information input through an input/output interface, according to an embodiment of the disclosure;

FIG. 3 is a diagram for describing an example of a guide related to a user authentication information restriction, which is output through an input/output interface, according to an embodiment of the disclosure;

FIG. 4 is a diagram for describing an example in which a processor of an electronic device outputs a user authentication information restriction through an input/output interface, according to an embodiment of the disclosure;

FIG. 5 is a diagram for describing an example in which a processor determines user input characteristics, according to an embodiment of the disclosure;

FIG. 6 is a diagram for describing an example of a pre-processing operation of an electronic device, according to an embodiment of the disclosure;

FIG. 7 is a diagram for describing examples of user input characteristics, according to an embodiment of the disclosure;

FIG. 8 is another diagram for describing examples of user input characteristics, according to an embodiment of the disclosure;

FIG. 9 is a diagram for describing an example in which user input characteristics are determined through comparison with user history information related to the user input characteristics, according to an embodiment of the disclosure;

FIG. 10A is a diagram for describing an example in which a processor changes locations of no-touch zones, according to an embodiment of the disclosure;

FIG. 10B is another diagram for describing an example in which a processor changes locations of no-touch zones, according to an embodiment of the disclosure;

FIG. 11 is a diagram for describing variances of user cryptography information registered without any user authentication information restriction, according to an embodiment of the disclosure;

FIG. 12 is a diagram for describing variances of user cryptography information registered when a curvature restriction for user authentication information is present, according to an embodiment of the disclosure;

FIG. 13 is a diagram for describing variances of user cryptography information registered when locations of no-touch zones are changed and updated, according to an embodiment of the disclosure;

FIGS. 14A and 14B are tables for describing an effect of improving authentication quality when locations of no-touch zones are changed and updated, according to various embodiments of the disclosure;

FIG. 15A is a diagram for describing an operation in which a processor performs user authentication, according to an embodiment of the disclosure;

FIG. 15B is another diagram for describing an operation in which a processor performs user authentication, according to an embodiment of the disclosure;

FIG. 16 is a diagram for describing a principle of performing user authentication by a processor, according to an embodiment of the disclosure;

FIG. 17A is a table showing a user authentication quality of an electronic device, according to an embodiment of the disclosure;

FIG. 17B is another table showing a user authentication quality of an electronic device, according to an embodiment of the disclosure;

FIG. 18 is a flowchart of a method of controlling an electronic device, according to an embodiment of the disclosure; and

FIG. 19 is a detailed flowchart of a method of controlling an electronic device, according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but are merely used to enable a clear and consistent understanding of the disclosure. Accordingly, it should be apparent to those skilled in the art that the following description of various embodiments of the disclosure is provided for illustration purpose only, and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Although the terms used herein are selected, as much as possible, from general terms that are widely used at present while taking into consideration the functions obtained in accordance with the disclosure, these terms may be replaced by other terms based on intentions of one of ordinary skill in the art, customs, emergence of new technologies, or the like. In a particular case, terms that are arbitrarily selected by the applicant may be used and, in this case, the meanings of these terms may be described in relevant parts of the disclosure. Therefore, it is noted that the terms used herein are construed based on practical meanings thereof and the whole content of this specification, rather than being simply construed based on names of the terms.

All terms (including technical and scientific terms) used herein have the same meaning as generally understood by one of ordinary skill in the art.

Throughout the disclosure, the expression “at least one of a, b or c” indicates only a, only b, only c, both a and b, both a and c, both b and c, all of a, b, and c, or variations thereof.

It will be understood that the terms “comprises,” “comprising,” “includes” and/or “including,” when used herein, specify the presence of stated elements, but do not preclude the presence or addition of one or more other elements, unless otherwise indicated herein.

Throughout the specification, like reference numerals denote like elements. Not all elements of embodiments of the disclosure are described herein, and descriptions of configurations generally known in the art or repeated descriptions between embodiments of the disclosure are omitted.

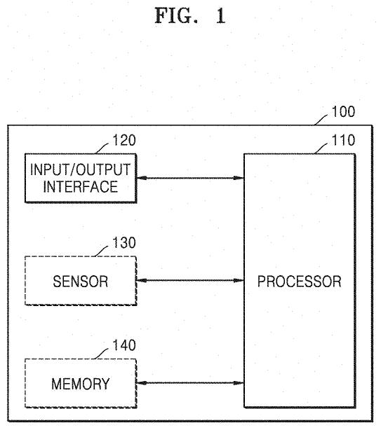

FIG. 1 is a block diagram of an electronic device 100 according to an embodiment of the disclosure.

Referring to FIG. 1, the electronic device 100 includes at least one processor 110 and an input/output interface 120. A memory 140 and/or a sensor 130, which is indicated by a dashed line, may be omitted depending on an embodiment of the disclosure.

In the present specification, configurations included in the electronic device 100 may be implemented as one or a combination of two or more of software, hardware, and firmware, and a plurality of configurations may be integrated into one element or one configuration may include a plurality of elements depending on embodiments of the disclosure.

In the present specification, the electronic device 100 may be implemented in various forms. For example, the electronic device 100 described in this specification may include a smartphone, a tablet personal computer (PC), a mobile phone, a video phone, an e-book reader, a desktop PC, a laptop PC, a netbook computer, a workstation, a server, a personal digital assistant (PDA), a portable multimedia player (PMP), a moving picture experts group phase 1 or phase 2 (MPEG-1 or MPEG-2) audio layer-3 (MP3) player, a mobile medical device, a camera, a wearable device, a lamp, a weighing scale, or a navigation system, but is not limited thereto. The electronic device 100 may include a home appliance. The home appliance may include, for example, a television, a digital versatile disk (DVD) player, a stereo system, a refrigerator, an air conditioner, a vacuum cleaner, an oven, a microwave, a washing machine, an air cleaner, a set-top box, a home automation control panel, a security control panel, a game console, an electronic key, a camcorder, or an electronic picture frame, but is not limited thereto.

The processor 110 controls overall operations of the electronic device 100. For example, the processor 110 may control the input/output interface 120 or the sensor 130 by executing programs stored in the memory 140. The processor 110 may include one or more processors.

The input/output interface 120 includes an interface capable of at least one of input or output. The input/output interface 120 may receive signals or information (hereinafter represented by information) and transmit the same to the processor 110. For example, the input/output interface 120 may include a display, a touchscreen, a touchpad, an audio inputter/outputter, a high-definition multimedia interface (HDMI), a universal serial bus (USB) interface, or a combination thereof, but is not limited thereto.

According to an embodiment of the disclosure, the processor 110 may output a user authentication information restriction through the input/output interface 120. The user authentication information restriction refers to a condition given to a character string, a pattern, or the like of user authentication information. The user authentication information restriction may be output in the form of at least one or a combination of, for example, text, image, sound, or vibration.

According to an embodiment of the disclosure, the processor 110 may receive user authentication information through the input/output interface 120. The user authentication information is received through the input/output interface 120 from a user. The user authentication information may be input in the form of at least one or a combination of, for example, gesture input, touch input, text input, or biosignal input. According to an embodiment of the disclosure, the input/output interface 120 may include a combination of a plurality of input/output devices or sensors.

According to an embodiment of the disclosure, the electronic device 100 may include the sensor 130. The sensor 130 may include at least one of a magnetic sensor, an acceleration sensor, a temperature/humidity sensor, an infrared sensor, a gyroscope sensor, a location sensor (e.g., a global positioning system (GPS)), a barometric pressure sensor, a proximity sensor, a fingerprint sensor, a biometric sensor, or a red-green-blue (RGB) (or illuminance) sensor, but is not limited thereto. The sensor 130 may obtain status or ambient environment information of the electronic device 100, and transmit the obtained information or signal to the processor 110. Functions of the sensors may be intuitively inferred from their names by one of ordinary skill in the art, and thus a detailed description thereof is not provided herein.

According to an embodiment of the disclosure, the electronic device 100 may include the memory 140. The memory 140 may store programs for processing and controlling operations of the processor 110, and store input/output information or signals (e.g., applications, contents, location information of the electronic device 100, an address book, or 2-dimensional barcode analysis information).

The memory 140 may include at least one type of storage medium from among flash memory, a hard disk, a multimedia card micro, a memory card (e.g., a secure digital (SD) or extreme digital (XD) card), random access memory (RAM), static RAM (SRAM), read-only memory (ROM), electrically erasable programmable ROM (EEPROM), programmable ROM (PROM), magnetic memory, a magnetic disc, or an optical disc. The electronic device 100 may use a web storage or a cloud server, which performs a storage function of the memory 140 on the Internet. The electronic device 100 may store or receive certain signals or data in or from the web storage or the cloud server by communicating with the web storage or the cloud server. Although the memory 140 is described below to provide convenience of understanding the disclosure, the memory 140 may be replaced by an external server for performing a storage function.

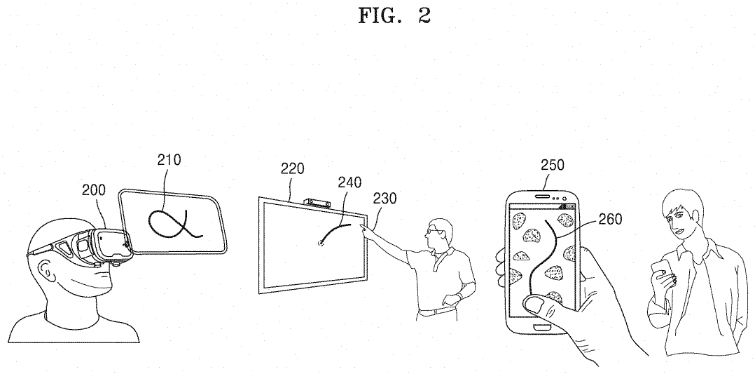

FIG. 2 is a diagram for describing examples of user authentication information or password information input through the input/output interface 120, according to an embodiment of the disclosure.

Referring to FIG. 2, user authentication information may refer to information input to register a user of the electronic device 100. For example, a fingerprint, an iris, a face, text, or a gesture may be used as the user authentication information.

User cryptography information may refer to criterion information for performing user authentication of the electronic device 100. In other words, user cryptography information may refer to registered user authentication information. Alternatively, the user cryptography information may include input user authentication information and user input characteristics.

The password information may refer to information input to perform user authentication after the user is registered in the electronic device 100.

When the electronic device 100 is a virtual reality (VR) device 200, the user may input the user authentication information or the password information by moving the VR device 200. The electronic device 100 may detect motion and a path of the electronic device 100 by using an acceleration sensor or a gyroscope sensor, and the processor 110 may obtain the user authentication information or the password information by using the detected path. The user authentication information or the password information may include a path 210 of the VR device 200.

When the electronic device 100 is a smart television (TV) 220, the user may input the user authentication information or the password information by moving a remote controller 230 facing the smart TV 220. According to an embodiment of the disclosure, the remote controller 230 includes an acceleration sensor or a gyroscope sensor, and detects a path 240 of the remote controller 230 by using the acceleration sensor or the gyroscope sensor. The smart TV 220 may obtain the user authentication information or the password information by using the path 240 of the remote controller 230, which is received from the remote controller 230. According to another embodiment of the disclosure, the smart TV 220 may detect the path 240 of the remote controller 230 by detecting a remote controller signal output from the remote controller 230 and detecting a path of coordinates at which the remote controller signal is detected on a display panel of the smart TV 220. The user authentication information or the password information may be the path 240 of the remote controller 230.

When the electronic device 100 is a smartphone 250, the user may input the user authentication information or the password information as a swipe on the smartphone 250. The smartphone 250 may detect a path 260 of the swipe input by the user on a touchscreen or a touchpad. The user authentication information or the password information may be the path 260 of the swipe.

However, the user authentication information or the password information is not limited to the examples of FIG. 2 and may also include biometric information (e.g., fingerprint, iris, or face information), voice information, or text.

As an example of the user authentication information or the password information, a gesture refers to information expressed as coordinates and varying over time. For example, each of the paths 210, 240, and 260 of FIG. 2 is expressed as 2-dimensional coordinates x,y and varies over time from a start to an end thereof, and thus corresponds to a gesture.

The user input characteristics may refer to user input properties capable of distinguishing the user from other users and including at least one of status information of the electronic device 100, ambient environment information of the electronic device 100, processing unit information of input user authentication information, or difference information between the input user authentication information and a user authentication information restriction.

A security level refers to a degree of maintaining security of the electronic device 100 and controlling the same to grant access only to authorized users. The security level may be defined by, for example, the type of the user authentication information required for user authentication, a combination of types of the user authentication information, or a data amount of the user authentication information. When the security level is high, the user authentication information restriction may be complicated.

A factor may refer to information used to perform user authentication of the electronic device 100. A multi-factor means that multiple pieces of user cryptography information are used to perform user authentication of the electronic device 100. For example, the processor 110 may perform multi-factor authentication when the input user authentication information and the user input characteristics are registered as the user cryptography information. That is, multi-factor authentication may be performed when the user cryptography information includes a plurality of pieces of information.

The user authentication information restriction refers to a cryptography strength required for the user authentication information to be registered in the electronic device 100 as the user cryptography information. For an example of the cryptography strength, when the type of the user authentication information is text, the user authentication information restriction may include at least one of a restriction not to include the date of birth or a mobile phone number of the user, or a restriction to include a combination of numbers, letters, and special characters. When the type of the user authentication information is a gesture, the user authentication information restriction may include a restriction to include at least one curve having a curvature equal to or greater than a certain value.

The user authentication information restriction may be changed according to the security level set for the electronic device 100. When the security level is high, the user authentication information restriction may be complicated. On the contrary, when the security level is low, no user authentication information restriction may be provided. For example, when the type of the user authentication information is text and the security level is low, even user authentication information including the date of birth or a mobile phone number of the user and not including a combination of numbers, letters, and special characters may be registered.

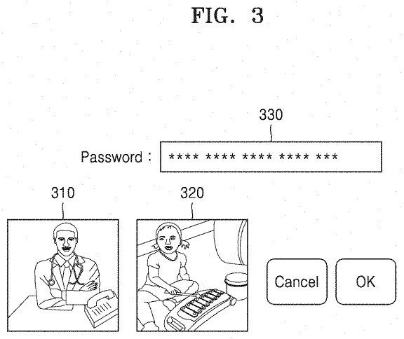

FIG. 3 is a diagram for describing an example of a guide related to a user authentication information restriction, which is output through the input/output interface 120, according to an embodiment of the disclosure.

Referring to FIG. 3, a guide related to input of user authentication information may include information for expressing a user authentication information restriction to be easily understood by a user, or information for helping the user to conveniently satisfy the user authentication information restriction. When the type of the user authentication information is text, the processor 110 may output an image or video satisfying a text restriction, through the input/output interface 120 based on user history information related to text. For example, an image related to text may include an image of a word or numbers frequently used by the user, or an image of a person.

When input user authentication information does not satisfy the user authentication information restriction, the processor 110 may output an image or video satisfying the user authentication information restriction, through the input/output interface 120 based on user history information related to the input user authentication information. For example, when the type of the user authentication information is text, the date of birth of a spouse is input, and an input text length 330 does not satisfy the user authentication information restriction, the processor 110 may output, through the input/output interface 120, a spouse image 310 or a child image 320 related to the input date of birth of the spouse. Therefore, the user may easily understand or satisfy the user authentication information restriction, based on the guide related to the user authentication information restriction.

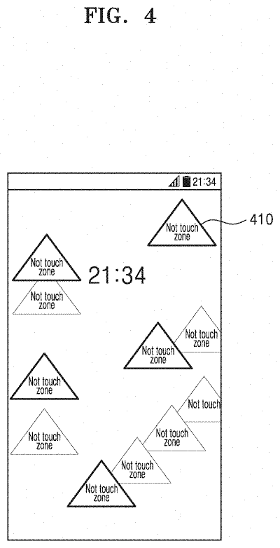

FIG. 4 is a diagram for describing an example in which the processor 110 of the electronic device 100 outputs a user authentication information restriction through the input/output interface 120, according to an embodiment of the disclosure.

Referring to FIG. 4, the user authentication information restriction may be output as at least one no-touch zone 410 through the input/output interface 120. The no-touch zone 410 may be output as an icon that is arbitrarily changeable according to user settings, and locations and the number of output no-touch zones 410 may be variously changed according to a security level set for the electronic device 100.

When the type of user authentication information is a gesture, the no-touch zone 410 may serve as a method of representing a cryptography strength by indirectly expressing the number or curvatures of curves. A user may intuitively recognize the no-touch zone 410 and easily understand the user authentication information restriction without complicatedly considering the number or curvatures of curves.

However, the no-touch zone 410 is merely an example of expressing the user authentication information restriction, and the user authentication information restriction is not limited thereto. The processor 110 may output the user authentication information restriction through the input/output interface 120 in various manners.

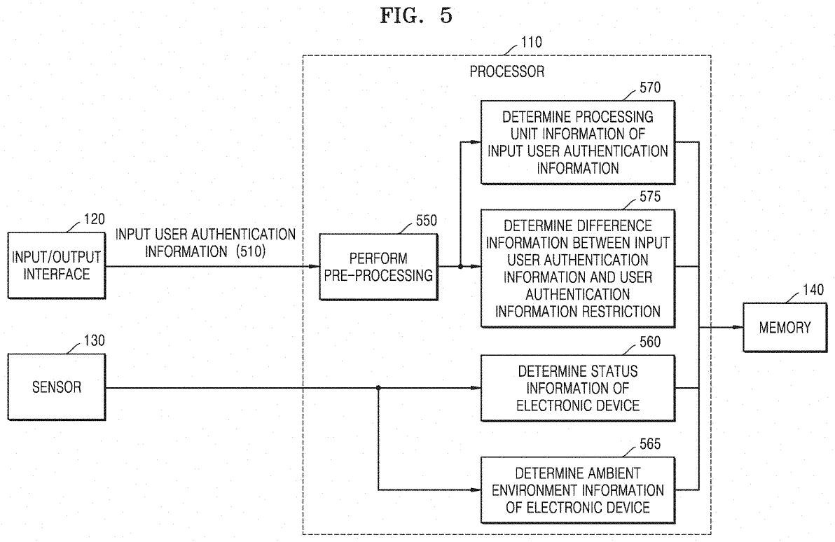

FIG. 5 is a diagram for describing an example in which the processor 110 of the electronic device 100 determines user input characteristics, according to an embodiment of the disclosure.

Referring to FIG. 5, a dashed line indicates that operation 550 for performing pre-processing, operation 560 for determining status information of the electronic device 100, operation 565 for determining ambient environment information of the electronic device 100, operation 570 for determining processing unit information of input user authentication information 510, and/or operation 575 for determining difference information between the input user authentication information 510 and a user authentication information restriction is performed within the processor 110, and does not indicate that such an operation may be omitted.

Operation 550 for performing pre-processing may include an operation for applying interpolation to the input user authentication information 510. Various interpolation methods such as linear interpolation, polynomial interpolation, and spline interpolation may be used. The processor 110 may perform pre-processing (operation 550) by applying an interpolation method appropriate for the input user authentication information 510 or input password information.

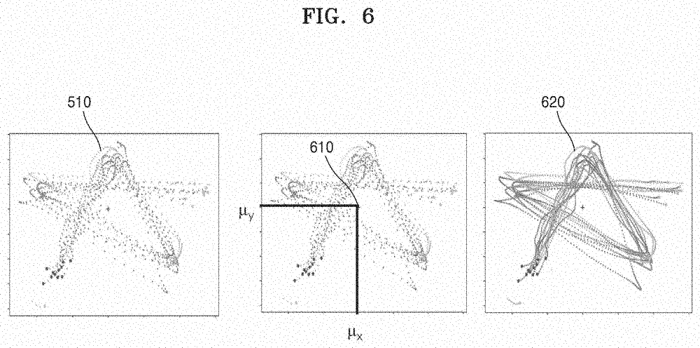

FIG. 6 is a diagram for describing an example of a pre-processing operation of the electronic device 100, according to an embodiment of the disclosure.

The processor 110 may perform pre-processing to remove noise in the input user authentication information 510 and consecutively express processing units of the input user authentication information 510. When a user inputs a gesture, the input user authentication information 510 may be expressed as coordinates x,y. An average 610 of the processing units of the input user authentication information 510 may be expressed as (μₓ, μ_{y}) corresponding to an x-coordinate average and a y-coordinate average of the input user authentication information 510. The average 610 of the processing units of the input user authentication information 510 may be used to train a Gaussian mixture model (GMM). A pre-processed result 620 may be obtained by applying linear interpolation to coordinate values of the input user authentication information 510.

Referring to FIG. 6, although a 2-dimensional vector including only the input user authentication information 510 as vector components is illustrated in FIG. 6 for convenience of understanding, a multi-dimensional vector including, as vector components, the input user authentication information 510 and at least one of status information of the electronic device 100, ambient environment information of the electronic device 100, processing unit information of the input user authentication information 510, or difference information between the input user authentication information 510 and a user authentication information restriction may also be used. For example, the processor 110 may perform processing as shown in Equation 1.

gᵢ={tᵢ,xᵢ,yᵢ,a1ᵢ,a2ᵢ, . . . ,aNᵢ} Equation 1

In this case, gᵢ denotes a vector including coordinate values xᵢ, yᵢ of the input user authentication information 510 in the 2-dimensional coordinate system, and additionally including N+1 components, when the type of the user authentication information 510 is a gesture. tᵢ denotes an input time of each pair of xᵢ, yᵢ. In some cases, tᵢ may not be a specific time value but may be a relative value expressed as an index according to an input order.

Further, a1ᵢ, a2ᵢ, . . . , aNᵢ may be at least one value from among the status information of the electronic device 100, the ambient environment information of the electronic device 100, the processing unit information of the input user authentication information 510, or the difference information between the input user authentication information 510 and the user authentication information restriction, which is determined by the processor 110. For example, a1ᵢ, a2ᵢ, . . . , aNᵢ may denote N pieces of information, e.g., a velocity, an angular velocity, and a distance at the coordinate values xᵢ, yᵢ of each processing unit, and an angle by which the electronic device 100 is tilted. Therefore, because a dimension of gᵢ is proportional to the number of included user input characteristics, when the dimension is high, enhanced security for user authentication may be achieved. Value gᵢ may serve as training data of the GMM.

The processor 110 may store, in the memory 140 as user input characteristics, information determined in at least one of operation 560 for determining the status information of the electronic device 100, operation 565 for determining the ambient environment information of the electronic device 100, operation 570 for determining the processing unit information of the input user authentication information 510, or operation 575 for determining the difference information between the input user authentication information 510 and the user authentication information restriction. As described above, when the processor 110 stores the user input characteristics in an external server, the memory 140 may be omitted.

The processor 110 may receive the user authentication information 510 multiple times to be registered as user cryptography information. Therefore, the input user authentication information 510 may include not only once input user authentication information but also user authentication information repeatedly input based on an updated user authentication information restriction.

The processor 110 may perform operation 570 for determining the processing unit information of the input user authentication information 510, based on a result of operation 550 for performing pre-processing.

A processing unit of the input user authentication information 510 may include a unit in which the input user authentication information 510 is converted into a mathematical expression and is processed by the processor 110, and vary depending on the type of the input user authentication information 510. For example, when the type of the input user authentication information 510 is text, the input user authentication information 510 may be processed in a string or number unit. When the type of the input user authentication information 510 is a gesture, the input user authentication information 510 may be processed in a coordinate unit. When the type of the input user authentication information 510 is voice, the input user authentication information 510 may be processed in a coordinate, frequency, or amplitude unit.

The processing unit information of the input user authentication information 510 may include a value obtained when the processor 110 analyzes each processing unit of the input user authentication information 510. For example, the processing unit information of the input user authentication information 510 may include a value obtained when the processor 110 mathematically analyzes each processing unit of the input user authentication information 510. When the type of the input user authentication information 510 is a gesture, the processing unit information of the input user authentication information 510 may include a value (e.g., a velocity, an angular velocity, an acceleration, or a distance between coordinates) obtained by mathematically analyzing each coordinate of the input user authentication information 510. The processor 110 may compare each processing unit (or processing unit information) of the repetitive input user authentication information 510 to each other per processing unit (or processing unit information), and determine maintenance by a user when a difference therebetween is within a set range. Because maintenance of the input user authentication information 510 means that input of the user authentication information 510 is familiar to the user, the user input characteristics may include a value by which the processor 110 expresses convenience or inconvenience felt by the user with the input user authentication information 510.

The processor 110 may perform operation 575 for determining the difference information between the input user authentication information 510 and the user authentication information restriction, based on the result of operation 550 for performing pre-processing.

The difference information between the input user authentication information 510 and the user authentication information restriction may include a value for expressing a degree by which the input user authentication information 510 satisfies the user authentication information restriction. For example, when the type of the input user authentication information 510 is a gesture, a gesture including a curve having a curvature of 0 is input, and a gesture restriction indicates to include two or more curves having a curvature equal to or greater than 0, the processor 110 may determine that a difference in the number of curves is −1 and that a difference in the curvature is 0. When a positive value in the difference information from the user authentication information restriction is within a set range, the processor 110 may determine that a corresponding user authentication information restriction is convenient for or familiar to the user. When a negative value in the difference information from the user authentication information restriction is within a set range, the processor 110 may determine that a corresponding user authentication information restriction is inconvenient for the user.

As described above, the user input characteristics may include a value by which the processor 110 expresses convenience or inconvenience felt by the user with the user authentication information restriction.

The processor 110 may perform operation 560 for determining the status information of the electronic device 100 or operation 565 for determining the ambient environment information of the electronic device 100, based on information obtained from the sensor 130.

Operation 560 for determining the status information of the electronic device 100 or operation 565 for determining the ambient environment information of the electronic device 100 may include an operation for determining status or ambient environment information of the electronic device 100, which is maintained by the user while the user authentication information 510 is being input multiple times. The sensor 130 transmit the status information (or ambient environment information) of the electronic device 100 to the processor 110.

While the user authentication information 510 is being input multiple times, the processor 110 may compare each of the multiple input of status information (or ambient environment information) to each other per corresponding order, and determine maintenance by the user when a difference therebetween is within a set range. For example, when the type of the user authentication information 510 is a gesture, the status information of the electronic device 100 may include a degree of tilting the electronic device 100 or a degree of touching the electronic device 100 (e.g., a touch area) and the ambient environment information of the electronic device 100 may include a distance between the electronic device 100 and the user while the user is inputting a curve. As described above, the processor 110 may express the user's habit of using the electronic device 100, as the user input characteristics.

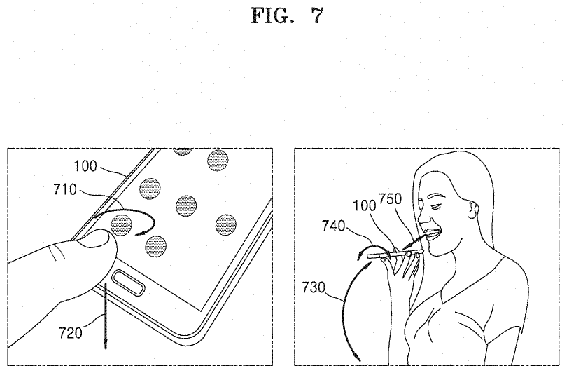

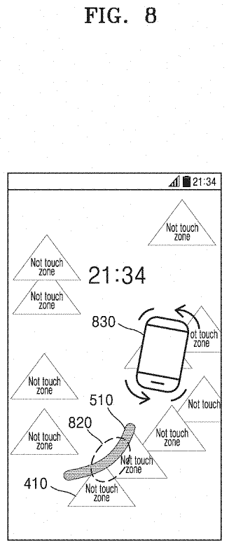

FIGS. 7 and 8 are diagrams for describing examples of user input characteristics, according to various embodiments of the disclosure.

Referring to FIGS. 7 and 8, the sensor 130 may obtain, through a proximity sensor, information indicating a timing when input of the user authentication information 510 starts to approach the input/output interface 120 of the electronic device 100. The processor 110 may generate distance information 720 to a location where input to the electronic device 100 starts, based on the type of electromagnetic waves used by the proximity sensor, the timing when input of the user authentication information 510 starts to approach, and a timing when the user authentication information 510 is input to the input/output interface 120. The processor 110 may generate angle information 710 of user input to the electronic device 100 on the basis of an arbitrary piece of the input user authentication information 510. While the user authentication information 510 is being input multiple times, the processor 110 may compare each of the multiple input of the angle information 710 (or the distance information 720 to the location where input to the electronic device 100 starts) of user input to each other per corresponding order, and determine maintenance by a user when a difference therebetween is within a set range.

The sensor 130 may generate, through a location sensor, location information indicating a location where the electronic device 100 is stopped and a location where the user inputs the user authentication information 510 to the electronic device 100, and obtain, through an angle sensor, angle information indicating an angle of the electronic device 100 at the location where the electronic device 100 is stopped and an angle of the electronic device 100 at the location where the user inputs the user authentication information 510 to the electronic device 100. The processor 110 may generate distance information 730 and angle information 740 by which the user moves and tilts the electronic device 100 to input the user authentication information 510, based on the location information and the angle information. When input of the user authentication information 510 is detected by a voice sensor, the sensor 130 may obtain, through an infrared sensor, input distance information 750 between the user and the electronic device 100. While the user authentication information 510 is being input multiple times, the processor 110 may compare each of the multiple input of the distance information 730 or the angle information 740 by which the user moves or tilts the electronic device 100 to input the user authentication information 510 or the input distance information 750 between the user and the electronic device 100, to each other per corresponding order, and determine maintenance by the user when a difference therebetween is within a set range.

Referring to FIG. 8, the difference information between the input user authentication information 510 and the user authentication information restriction may include overlapping information 820 between the no-touch zones 410 and the input user authentication information 510. The processor 110 may perform operation 575 for determining the difference information between the input user authentication information 510 and the user authentication information restriction, based on an overlapping area between the no-touch zone 410 and the input user authentication information 510.

The sensor 130 may obtain tilting information 830 of the electronic device 100 while the user is inputting the user authentication information 510. When a difference in the tilting information 830 of the electronic device 100 while the user is inputting the user authentication information 510 multiple times is within a set range, the processor 110 may determine maintenance by the user and determine the same as user input characteristics. The sensor 130 may obtain the tilting information 830 of the electronic device 100 at a specific point of the input user authentication information 510, and the processor 110 may determine the same as the user input characteristics.

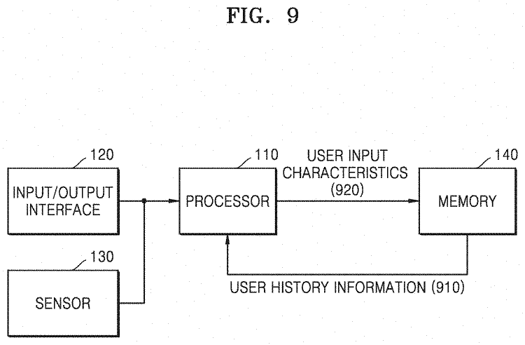

FIG. 9 is a diagram for describing an example in which user input characteristics 920 are determined through comparison with user history information 910 related to the user input characteristics 920, according to an embodiment of the disclosure.

Referring to FIG. 9, the user history information 910 may include information related to at least one of status information of the electronic device 100, ambient environment information of the electronic device 100, processing unit information of the input user authentication information 510, or difference information between the input user authentication information 510 and a user authentication information restriction. For example, the user history information 910 may include information related to text, the number or curvatures of curves, a degree of tilting the electronic device 100 while a user is inputting a curve, a tilt angle, a distance between the electronic device 100 and the user, a touch area between the electronic device 100 and the user, a touch pressure, the angle information 710 of user input, the distance information 720 to the location where input to the electronic device 100 starts, the distance information 730 by which the user moves the electronic device 100, the angle information 740 by which the user tilts the electronic device 100, the input distance information 750 between the user and the electronic device 100, the overlapping information 820 between the no-touch zones 410 and the input user authentication information 510, and the tilting information 830 of the electronic device 100 while the user is inputting the user authentication information 510. The memory 140 may store the user history information 910 related to the user input characteristics 920.

The processor 110 may determine the user input characteristics 920 in consideration of a repetition rate of the above-described user history information 910. When the repetition rate of the user history information 910 is equal to or greater than a set repetition rate, the processor 110 may determine the same as the user input characteristics 920. Because frequent use by the user means convenience for or familiarity to the user, the user input characteristics 920 may be determined as information convenient for or familiar to the user. The processor 110 may include the user input characteristics 920 in user cryptography information and perform multi-factor authentication.

The processor 110 may determine the user input characteristics 920, based on the user authentication information 510 input based on the user authentication information restriction, and update the user authentication information restriction, based on the user input characteristics 920.

The processor 110 may update the user authentication information restriction, based on the processing unit information of the input user authentication information 510. The processor 110 may compare each processing unit (or processing unit information) of the input user authentication information 510 to each other per corresponding order, and determine maintenance by the user when a difference therebetween is within a set range.

The processor 110 may update the user authentication information restriction to that related to the input user authentication information 510 maintained by the user. Therefore, because the maintenance by the user means familiarity to or convenience for the user, the user authentication information restriction may be updated to that convenient for or familiar to the user.

The processor 110 may update the user authentication information restriction, based on the difference information between the input user authentication information 510 and the user authentication information restriction. The processor 110 may update the user authentication information restriction to that related to a positive value of the difference information between the input user authentication information 510 and the user authentication information restriction within a set range. The processor 110 may update the user authentication information restriction by excluding that related to a negative value of the difference information between the input user authentication information 510 and the user authentication information restriction within a set range.

Therefore, because the positive value of the difference information between the input user authentication information 510 and the user authentication information restriction within the set range means that the user authentication information restriction is convenient for and familiar to the user, the processor 110 may update the user authentication information restriction to that convenient for and familiar to the user.

The processor 110 may update the user authentication information restriction, based on the status information or the ambient environment information of the electronic device 100. When the status information or the ambient environment information of the electronic device 100 greatly varies out of a set range while the user authentication information 510 is being input, the processor 110 may update the user authentication information restriction by excluding that related to the input user authentication information 510 or the user authentication information restriction at a timing that the user authentication information 510 is input. For example, when the type of the user authentication information 510 is a gesture and a tilt angle of the electronic device 100 greatly varies out of the set range while the user authentication information 510 is being input, the processor 110 may update the user authentication information restriction by reducing a curvature at a corresponding timing.

Therefore, because the case when the status information or the ambient environment information of the electronic device 100 greatly varies out of the set range while the user authentication information 510 is being input, the processor 110 means that the input user authentication information 510 or the user authentication information restriction at a corresponding timing is inconvenient, the processor 110 may update the user authentication information restriction to that convenient for or familiar to the user.

As described above, the processor 110 may update the user authentication information restriction in a user-adaptive. The user may sufficiently understand and practice the user authentication information restriction for the user during the update process and thus the input user authentication information 510 may have a small variance and have consistency.

When the input user authentication information 510 and the user input characteristics 920 are registered as the user cryptography information (i.e., a multi-factor), although the input user authentication information 510 is simple, because the user input characteristics 920 are also included in the user cryptography information, a security level set for the electronic device 100 is maintained and is not lowered.

The user authentication information restriction may include a plurality of restrictions. The processor 110 may update at least one of the plurality of restrictions. When the security level set for the electronic device 100 is high, the number of restrictions may be greater than that of a case when the security level is low. When the input user authentication information 510 satisfies only some of the plurality of restrictions, the processor 110 may update only the satisfied restrictions.

Although only some of the plurality of restrictions are excessively satisfied and the other restrictions are not satisfied, the processor 110 may register the input user authentication information 510 as the user cryptography information. For example, when the type of the user authentication information 510 is text and a text length of 10 is set but the user inputs text at a length equal to or greater than 20, although the other restrictions (e.g., a restriction to include the date of birth) are not satisfied, the processor 110 may register the input user authentication information 510 and the user input characteristics 920 as the user cryptography information.

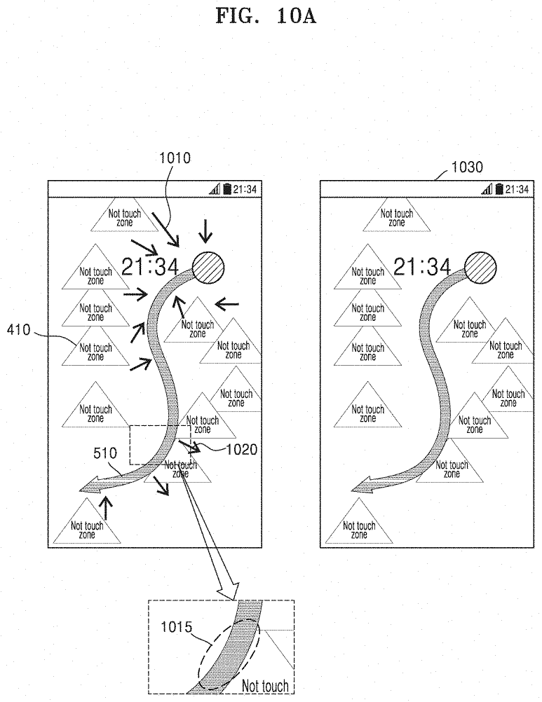

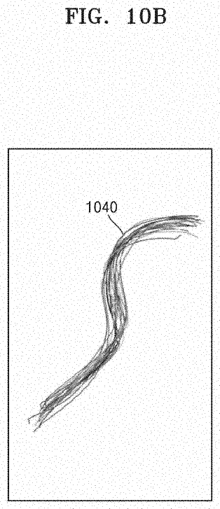

FIGS. 10A and 10B are diagrams for describing an example in which the processor 110 updates a user authentication information restriction by changing locations of the no-touch zones 410, according to an embodiment of the disclosure.

Referring to FIGS. 1 and 10A, the processor 110 may update (see reference numeral 1030) locations of the no-touch zones 410, based on difference information between the input user authentication information 510 and the no-touch zones 410. The overlapping between the no-touch zone 410 and the input user authentication information 510 may mean that touching a corresponding region is convenient for a user. In another aspect, the location of a corresponding no-touch zone 410 is inconvenient.

When the input user authentication information 510 overlaps with a no-touch zone 410, the processor 110 may determine a direction 1020 and a distance to move the overlapping no-touch zone 410, based on an overlapping area between the input user authentication information 510 and the no-touch zone 410, a location 1015 of an overlapping region, and a shape of the input user authentication information 510.

When the input user authentication information 510 does not overlap with a no-touch zone 410, the processor 110 may determine a direction 1010 and a distance to move the non-overlapping no-touch zone 410, based on a distance and a gradient of a shortest distance line between the input user authentication information 510 and the no-touch zone 410, and the shape of the input user authentication information 510. The location 1015 of the overlapping region means a location of a region where an icon of the no-touch zone 410 overlaps with the input user authentication information 510. According to the above-described principle, the processor 110 may reduce or increase the sizes of the no-touch zones 410, based on the difference information between the input user authentication information 510 and the no-touch zones 410. As described above, the processor 110 may update the user authentication information restriction to a user-adaptive restriction convenient for the user.

Referring to FIG. 10B, the user may input the user authentication information 510 again after the processor 110 updates the user authentication information restriction by changing locations of the no-touch zones 410. Therefore, user cryptography information 1040 of FIG. 10B may have a small variance and have consistency. The process of FIG. 10A may be repeated until the variance of the input user authentication information 510 is within a set range. The user may sufficiently understand and practice the user authentication information of the user during the repeated process.

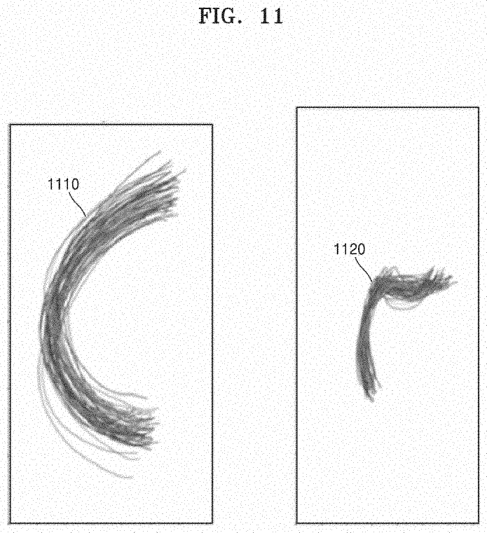

FIG. 11 is a diagram for describing variances of user cryptography information 1110 and 1120 registered without any user authentication information restriction, according to an embodiment of the disclosure.

Referring to FIG. 11, a diagram is shown for describing an example in which, when the type of the input user authentication information 510 is a gesture, the user cryptography information 1110 and 1120 do not have consistency and have large variances.

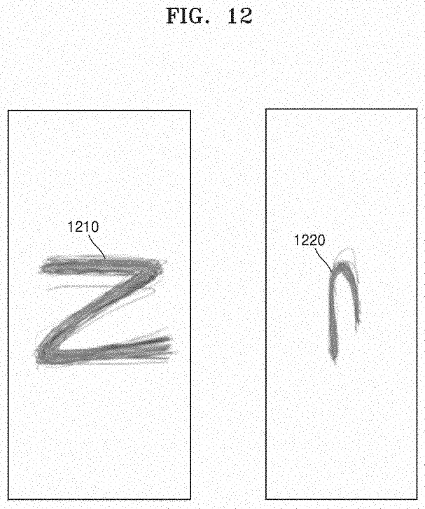

FIG. 12 is a diagram for describing variances of user cryptography information 1210 and 1220 registered when a curvature restriction for the user authentication information 510 is present, according to an embodiment of the disclosure.

Referring to FIG. 12, a diagram is shown for describing an example in which, when the type of the input user authentication information 510 is a gesture and the curvature restriction is present, the user cryptography information 1210 and 1220 do not have consistency and have large variances.

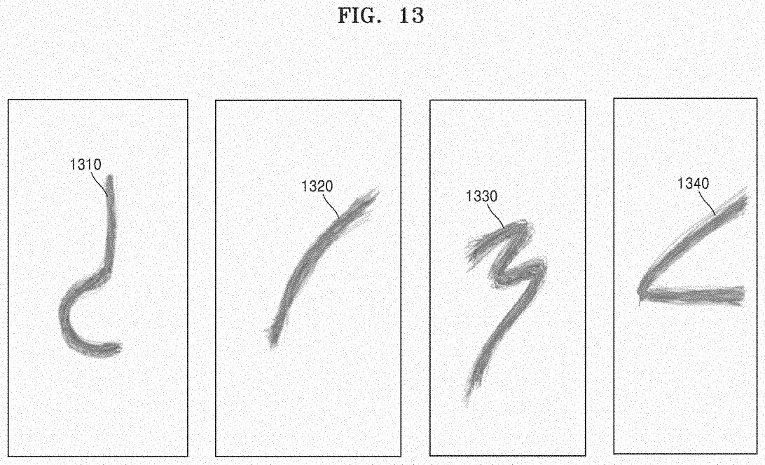

FIG. 13 is a diagram for describing variances of user cryptography information 1310, 1320, 1330, and 1340 registered when locations of the no-touch zones 410 are changed and updated, according to an embodiment of the disclosure.

FIGS. 11, 12, and 13 will now be compared to show that the variances of the user cryptography information 1310, 1320, 1330, and 1340 registered when the locations of the no-touch zones 410 are changed and updated, according to an embodiment of the disclosure, are reduced.

A variance of user cryptography information may be related to an evaluation factor of authentication quality, e.g., a false acceptance rate (FAR) or a false rejection rate (FRR), when the processor 110 performs user authentication.

The FAR and the FRR may be calculated for each piece of the user cryptography information. Therefore, when the user cryptography information has a large variance, the user cryptography information may have been input in various manners and thus the FAR and the FRR may be increased. On the contrary, when the user cryptography information has a small variance, the user cryptography information may have been input in equal or similar manners and thus the FAR and the FRR may be reduced. Therefore, when the variance of the user cryptography information is reduced, authentication quality may be improved.

The variance of the user cryptography information may be related to reproducibility of the user cryptography information when the processor 110 performs user authentication. A large variance of the user cryptography information may mean that the user cryptography information is inconvenient for or unfamiliar to a user. When user authentication information inconvenient for or unfamiliar to the user is registered as the user cryptography information, the user may not easily reproduce the user cryptography information. On the contrary, a small variance of the user cryptography information may mean that the user cryptography information is convenient or familiar. When the user cryptography information is convenient for or familiar to the user, the user may easily reproduce the user cryptography information.

When the variances of the user cryptography information shown in FIGS. 11, 12, and 13 are compared, the variances of the user cryptography information 1310, 1320, 1330, and 1340 of FIG. 13 are smaller than the variances of the user cryptography information 1110, 1120, 1210, and 1220 of FIGS. 11 and 12. Therefore, when the locations of the no-touch zones 410 are changed and updated, a user may easily reproduce the user cryptography information compared to FIGS. 11 and 12 and authentication quality may be improved.

The user cryptography information 1310, 1330, and 1340 of FIG. 13 show cases when the processor 110 performs user authentication, based on the input user authentication information 510. On the contrary, the user cryptography information 1320 of FIG. 13 shows a case when a user authentication information restriction is updated based on user input characteristics indicating that inputting a curve is inconvenient for the user. Although a curvature restriction is not present, the processor 110 may perform user authentication, based on the user cryptography information including the input user authentication information 510 and the user input characteristics (i.e., a multi-factor) and thus security may not be weakened. Therefore, the user may perform user authentication by using convenient and simple user cryptography information.

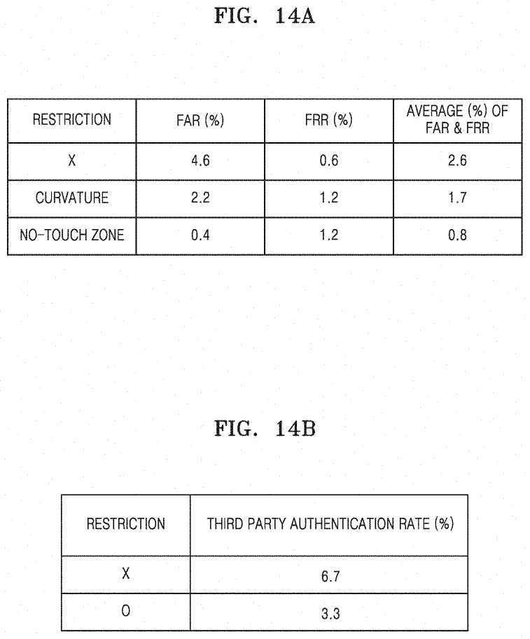

FIGS. 14A and 14B are tables for describing an effect of improving authentication quality when locations of the no-touch zones 410 are changed and updated, according to various embodiments of the disclosure.

Referring to FIG. 14A, the table shows a FAR and an FRR when 30 users are registered based on a given user authentication information restriction and user authentication is repeated five times. When the users are registered without any user authentication information restriction, the FAR is 4.6% and the FRR is 0.6%. When the users are registered based on a curvature restriction, the FAR is 2.2% and the FRR is 1.2%. When the users are registered by changing and updating the locations of the no-touch zone 410, the FAR is 0.4% and the FRR is 1.2%. False acceptance means that an unauthorized user may be authenticated, and thus may be a serious problem for security. Therefore, when the users are registered by changing and updating the locations of the no-touch zone 410, the FAR has a remarkably low value compared to the other cases and thus authentication quality may be improved.

Referring to FIG. 14B, the table shows an authentication rate by a third person when 30 users are registered depending on presence of a user authentication information restriction and the third person performs user authentication 40 times by randomly inputting password information. The table shows that the user authentication information restriction may provide enhanced user authentication security and improved authentication quality.

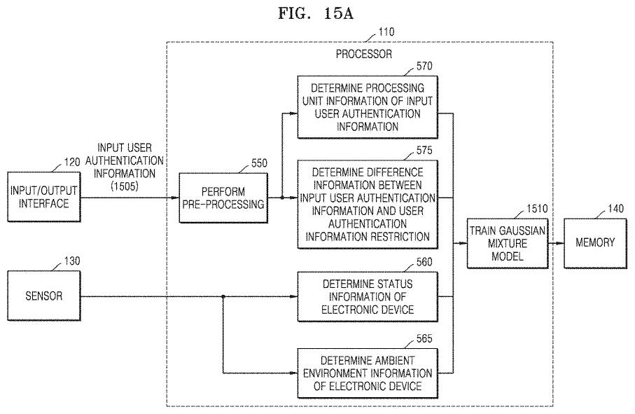

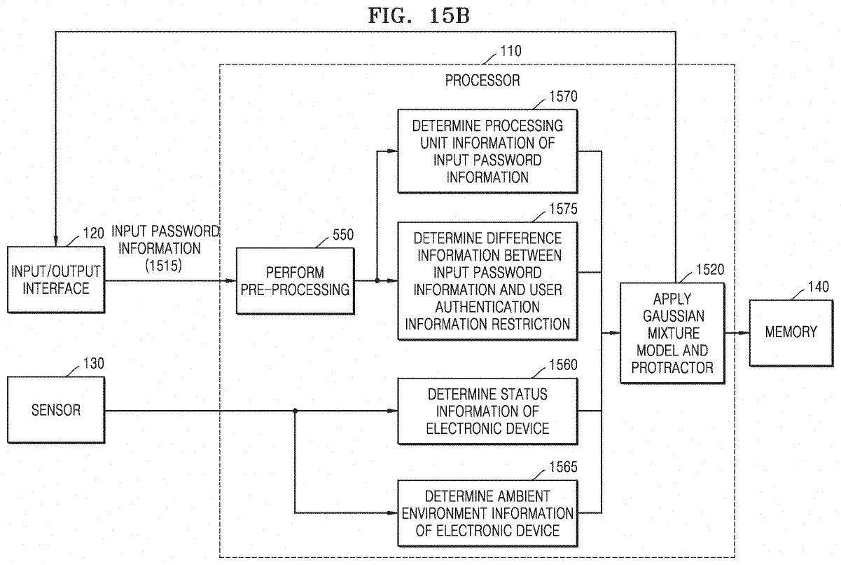

FIGS. 15A and 15B are diagrams for describing an operation in which the processor 110 performs user authentication, according to an embodiment of the disclosure.

Referring to FIGS. 15A and 15B, FIG. 15A describes a procedure of registering input user authentication information 1505 as user cryptography information, and FIG. 15B describes a procedure of performing user authentication, based on input password information. Operation 550 for performing pre-processing, operation 560 for determining status information of the electronic device 100, operation 565 for determining ambient environment information of the electronic device 100, operation 570 for determining processing unit information of the input user authentication information 1505, and operation 575 for determining difference information between the input user authentication information 1505 and a user authentication information restriction are the same as those described above in detail in relation to FIG. 5.

A GMM is merely an example for describing an operation of performing user authentication (i.e., an operation of comparing input password information with user cryptography information). Therefore, the user cryptography information may be trained based on supervised learning. Although the GMM is a representative example of unsupervised learning, various types of unsupervised learning may be applied to perform user authentication. In the following description, for convenience of understanding, the operation of performing user authentication is performed using the GMM.

Operation 1510 for training the GMM according to an embodiment of the disclosure in FIG. 15A may be performed based on the user cryptography information as described above. Specifically, when multi-factor authentication is performed, the user cryptography information may be a vector including the input user authentication information 1505 and additionally including at least one of the status information of the electronic device 100, the ambient environment information of the electronic device 100, the processing unit information of the input user authentication information 1505, or the difference information between the input user authentication information 1505 and the user authentication information restriction. For security of the electronic device 100 and registration of simple user authentication information, multi-factor authentication may be desired.

The GMM may be trained using an expectation-maximization (EM) algorithm. In this case, the number of Gaussian distributions may be determined as a dimension of a training data vector. In another aspect, the number of Gaussian distributions (e.g., the number of clusters) may be automatically determined using a K-means algorithm by the processor 110. The GMM training algorithm is known well and thus a detailed description thereof is not provided herein.

The memory 140 according to an embodiment of the disclosure in FIG. 15B may store the GMM trained based on the user cryptography information in FIG. 15A.

In FIG. 15B, the processor 110 may perform operation 1570 for determining processing unit information of input password information 1515, operation 1560 for determining status information of the electronic device 100, or operation 1565 for determining ambient environment information of the electronic device 100. Except for input information, operations of FIG. 15B are the same as those of FIG. 15A.

The processor 110 may perform operation 1575 for determining difference information between the input password information 1515 and the user authentication information restriction. When the password information 1515 is input, the processor 110 may not output the user authentication information restriction through the input/output interface 120.

The memory 140 may store the user authentication information restriction applied until the input user authentication information 1505 is registered as the user cryptography information by the processor 110 in FIG. 15A. The processor 110 may compare the input password information 1515 with the user authentication information restriction stored in the memory 140, and determine the difference information therebetween. Except for input information, operation 1575 is the same as operation 575 of FIG. 15A.

When the password information 1515 is input, the processor 110 may perform only an operation of determining information corresponding to the user cryptography information. The processor 110 may perform operation 1520 for applying the GMM and a protractor to the determined information, and output a result thereof through the input/output interface 120. For example, when the user cryptography information includes the input user authentication information 1505, a distance between the electronic device 100 and the user, and an overlapping area between the no-touch zone 410 and the input user authentication information 1505, the processor 110 may apply the GMM and the protractor to the input password information 1515, a distance between the electronic device 100 and the user, and an overlapping area between the no-touch zone 410 and the input password information 1515, which correspond to the user cryptography information.

However, as described above, the no-touch zones 410 may not be output through the input/output interface 120. Therefore, the processor 110 may use location information and the overlapping information 820 of the no-touch zones 410, which are applied until the input user authentication information 1505 is registered as the user cryptography information and are stored in the memory 140.

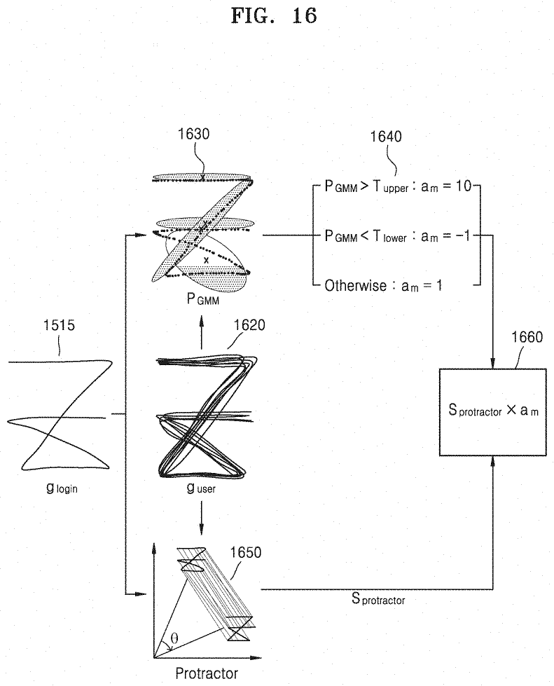

FIG. 16 is a diagram for describing a principle of performing user authentication by the processor 110, according to an embodiment of the disclosure.

Referring to FIG. 16, the processor 110 may obtain a probability value of the input password information 1515 by applying a GMM training result 1630 stored in the memory 140, to the input password information 1515. The obtained probability value may be converted into a set value by using a threshold table 1640.

The processor 110 may apply a protractor 1650 to the input password information 1515 and user cryptography information 1620. The protractor 1650 may calculate an angle distance, determine the user cryptography information 1620 most similar to the input password information 1515, and obtain the probability value of the input password information 1515.

The processor 110 may calculate a similarity 1660 by multiplying the value converted using the threshold table 1640 by the probability value obtained using the protractor 1650, and perform user authentication. The similarity 1660 may be more accurately calculated using both of the GMM training result 1630 and the protractor 1650 compared to a case using only one of them. The GMM does not consider a sequence or time but the protractor 1650 considers. Therefore, the two probability values correspond to independent events and thus more accurate user authentication may be performed.

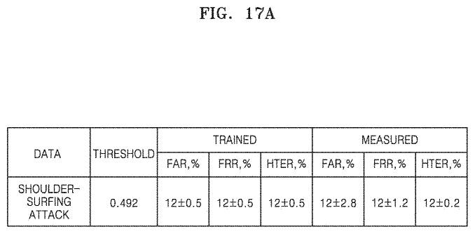

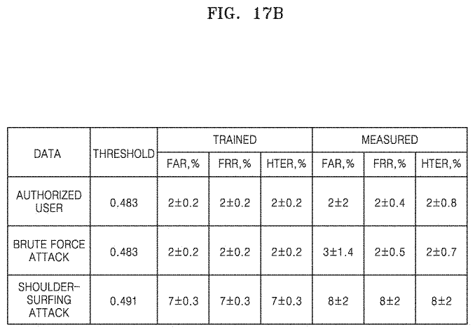

FIGS. 17A and 17B are tables showing authentication quality of the electronic device 100, according to an embodiment of the disclosure.

Referring to FIG. 17A, the table shows authentication quality measured when user authentication is performed by registering only input user authentication information as user cryptography information.

Referring to FIG. 17B, the table shows authentication quality measured when multi-factor authentication is performed by registering input user authentication information and user input characteristics as user cryptography information. In each table, FAR is the abbreviation of a false acceptance rate. FRR is the abbreviation of a false rejection rate. HTER is the abbreviation of a half total error rate and is an average of the FAR and the FRR. Brute force attack refers to a case when a third person not knowing the user cryptography information randomly inputs password information. SHOULDER-SURFING ATTACK refers to a case when a third person knowing the user cryptography information imitates the user cryptography information.

In FIG. 17B, AUTHORIZED USER refers to a case when an authorized user of the electronic device 100 performs user authentication. When measured SHOULDER-SURFING ATTACK authentication quality data of FIGS. 17A and 17B are compared, the FAR and the FRR are reduced and thus it may be regarded that the authentication quality of FIG. 17B is improved compared to that of FIG. 17A. Comparison of Brute force attack data is not appropriate due to the data characteristics of randomness. The SHOULDER-SURFING ATTACK data of FIGS. 17A and 17B differ depending on whether user input characteristics are registered as the user cryptography information. Therefore, the comparison of FIGS. 17A and 17B shows that authentication quality may be improved when multi-factor authentication is performed using the user cryptography information including the input user authentication information and the user input characteristics.

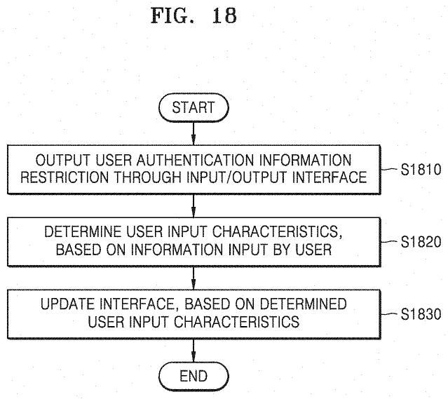

FIG. 18 is a flowchart of a method of controlling the electronic device 100, according to an embodiment of the disclosure.

Referring to FIG. 18, operation S1810 is an operation of outputting a user authentication information restriction through the input/output interface 120. When the type of user authentication information is text, the user authentication information restriction may include at least one of a restriction not to include the date of birth or a mobile phone number of a user, or a restriction to include a combination of numbers, letters, and special characters. When the type of the user authentication information is a gesture, the user authentication information restriction may include a restriction to include at least one curve having a curvature equal to or greater than a certain value. The user may input user authentication information, based on the output user authentication information restriction.

Operation S1820 is an operation, performed by the processor 110, of determining user input characteristics, based on the user authentication information input based on the user authentication information restriction.

The user input characteristics may include at least one of status information of the electronic device 100, ambient environment information of the electronic device 100, processing unit information of the input user authentication information, or difference information between the input user authentication information and the user authentication information restriction. When the user input characteristics are included in user cryptography information and used as training data of a GMM, multi-factor authentication may be performed.

Operation S1830 is an operation of outputting, through the input/output interface 120, the user authentication information restriction updated based on the user input characteristics. As described above, the user input characteristics may include a value for expressing convenience or inconvenience felt by the user or habits of using the electronic device 100. Therefore, the user authentication information restriction updated based on the user input characteristics may be a user-adaptive restriction convenient for and familiar to the user. A detailed description thereof is provided above.

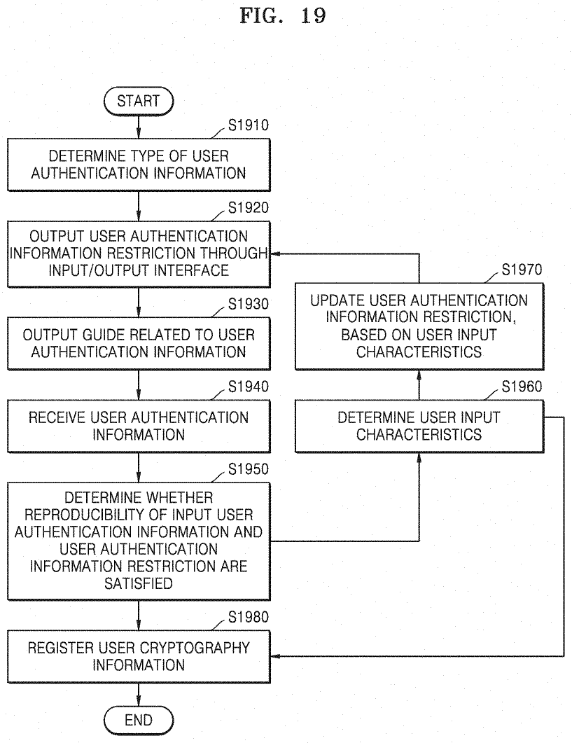

FIG. 19 is a detailed flowchart of a method of controlling the electronic device 100, according to an embodiment of the disclosure.

Referring to FIG. 19, the detailed flowchart of FIG. 19 is merely to promote understanding of operations and any one of the operations may be omitted without departing from the scope of the disclosure.

Operation S1910 is an operation of determining one of types of user authentication information, which are output through the input/output interface 120, based on selection of a user. For example, the user may select one of different types of user authentication information, e.g., a fingerprint, an iris, a face, text, or a gesture. In some cases, the user may select multiple types of user authentication information. For example, the user may select a fingerprint and text as the types of user authentication information and both of fingerprint information and text information may be registered as user cryptography information.

Operation S1920 is an operation of outputting, through the input/output interface 120, a user authentication information restriction corresponding to the determined type. When multiple types of user authentication information are selected, the user authentication information restriction corresponding to each type may be output. Except for the above description, operation S1920 is the same as operation S1810.

Operation S1930 is an operation of outputting a guide related to input of user authentication information. The guide related to input of user authentication information may include information for expressing the user authentication information restriction to be easily understood by the user, or information for helping the user to conveniently satisfy the user authentication information restriction. A detailed description thereof is provided above in relation to FIG. 3.

Operation S1940 is an operation of receiving user authentication information input based on the user authentication information restriction. The electronic device 100 may receive the input user authentication information multiple times to achieve reproducibility of the input user authentication information and determine user input characteristics.

Operation S1950 is an operation of determining whether the reproducibility of the input user authentication information and the user authentication information restriction are satisfied. When any of the reproducibility of the input user authentication information and the user authentication information restriction is not satisfied, the processor 110 may proceed to operation S1960. On the contrary, when both of the reproducibility of the input user authentication information and the user authentication information restriction are satisfied, the processor 110 may proceed to operation S1980.

Operation S1960 is an operation of determining user input characteristics. A detailed description thereof is provided above in relation to FIGS. 5 and 9.

Operation S1970 is an operation of updating the user authentication information restriction, based on the user input characteristics. As described above, the user authentication information restriction updated based on the user input characteristics may be a user-adaptive restriction convenient for and familiar to the user. Operation S1970 is the same as operation S1830 of FIG. 18.

Operation S1980 is an operation of registering user cryptography information. The user cryptography information including the input user authentication information and the user input characteristics may be registered and multi-factor authentication may be performed to improve authentication quality. In this case, as described above, although the user authentication information restriction and the input user authentication information are simple, a security level set for the electronic device 100 may be maintained without being weakened. The user cryptography information is registered after the user authentication information restriction is updated based on the user input characteristics in operation S1970, and thus may have a small variance.

In this specification, a setting value such as a set range or a setting rate may vary depending on the electronic device 100 or be arbitrarily changed by the user. Each setting value may be learned by the processor 110 based on the user's pattern of using the electronic device 100 in relation to the setting value. For example, when maintenance by the user is determined based on a set range of a difference in the angle information 710 of user input to the electronic device 100, the set range may be learned based on an angle of ordinary user input to the electronic device 100.

The afore-described embodiments of the disclosure may be implemented as a software program including instructions stored in a computer-readable storage medium. The afore-described embodiments of the disclosure may be implemented as a computer-readable storage medium having a computer program stored therein.

The computer is a device capable of fetching instructions stored in a storage medium, and operating according to the embodiments of the disclosure based on the fetched instructions, and may include an electronic device according to the embodiments of the disclosure.

The computer-readable storage medium may be provided in the form of a non-transitory storage medium. When the storage medium is “non-transitory,” it merely means that the storage medium is tangible and does not include signals (e.g., electromagnetic waves), and it does not limit that data is semi-permanently or temporarily stored in the storage medium. For example, the “non-transitory storage medium” may include a buffer for temporarily storing data.

An electronic device or a method of controlling the same, according to the embodiments of the disclosure, may be included and provided in a computer program product. The computer program product may be traded between sellers and buyers.

The computer program product may be distributed in the form of a software program, a computer-readable storage medium having the software program stored therein, or a machine-readable storage medium (e.g., compact disc read only memory (CD-ROM)), or be distributed online (e.g., downloaded or uploaded) via an application store (e.g., Play Store™) or directly between two user devices (e.g., smartphones). For online distribution, at least a part of the computer program product (e.g., a downloadable app) may be at least temporarily stored in the machine-readable storage medium such as a server of a manufacturer, a server of the application store, or a memory of a relay server, or be temporarily created.

In a system including a server and a terminal (e.g., an electronic device, a portable electronic device, or a wearable device), the computer program product may include a storage medium of the server or the terminal. Otherwise, when a third device (e.g., a smartphone) connected to the server or the terminal is present, the computer program product may include a storage medium of the third device. Alternatively, the computer program product may include a software program itself that is transmitted from the server to the terminal or the third device, or from the third device to the terminal.

In this case, one of the server, the terminal, and the third device may execute the computer program product to perform the method according to the embodiments of the disclosure. Alternatively, two or more of the server, the terminal, and the third device may execute the computer program product to perform the method according to the embodiments of the disclosure in a distributed fashion.

For example, the server (e.g., a cloud server or an artificial intelligence (AI) server) may execute the computer program product stored in the server to control the terminal connected to the server to perform the method according to the embodiments of the disclosure.

As another example, the third device may execute the computer program product to control the terminal connected to the third device to perform the method according to the embodiments of the disclosure. Specifically, for example, the third device may remotely control the electronic device to perform the method according to the embodiments of the disclosure.

When the third device executes the computer program product, the third device may download the computer program product from the server and execute the downloaded computer program product. Alternatively, the third device may execute the computer program product provided in a preloaded state to perform the method according to the embodiments of the disclosure.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device comprising:
an input/output interface; and
one or more processors configured to:
output a user authentication information restriction through the input/output interface,
determine user input characteristics, based on user authentication information input based on the user authentication information restriction, and
output, through the input/output interface, the user authentication information restriction updated based on the determined user input characteristics.

2. The electronic device of claim 1, wherein the one or more processors are further configured to perform user authentication, based on the input user authentication information and the user input characteristics.

3. The electronic device of claim 1, wherein the one or more processors are further configured to output a guide related to the user authentication information restriction, through the input/output interface based on user history information related to the user authentication information restriction.

4. The electronic device of claim 1, wherein the outputting of the user authentication information restriction through the input/output interface comprises outputting at least one no-touch zone.

5. The electronic device of claim 1, further comprising:
a sensor configured to obtain status or ambient environment information of the electronic device,
wherein the user input characteristics comprise at least one of processing unit information of the input user authentication information, difference information between the input user authentication information and the user authentication information restriction, or the status or ambient environment information of the electronic device maintained by a user while the user authentication information is being input.

6. The electronic device of claim 5, wherein the determining of the user input characteristics comprises determining the user input characteristics through comparison with user history information related to the user input characteristics to the electronic device.

7. The electronic device of claim 1,
wherein the user authentication information restriction comprises a plurality of restrictions, and
wherein the user authentication information restriction updated based on the determined user input characteristics comprises at least one restriction updated from among the plurality of restrictions.

8. The electronic device of claim 4, wherein the user authentication information restriction updated based on the determined user input characteristics comprises the at least one no-touch zone, a location of which is changed and updated based on the determined user input characteristics.

9. A method of controlling an electronic device, the method comprising:
outputting a user authentication information restriction through an input/output interface;
determining user input characteristics, based on user authentication information input based on the user authentication information restriction; and
outputting, through the input/output interface, the user authentication information restriction updated based on the determined user input characteristics.

10. The method of claim 9, further comprising performing user authentication, based on the input user authentication information and the user input characteristics.

11. The method of claim 9, wherein the outputting of the user authentication information restriction through the input/output interface comprises outputting a guide related to the user authentication information restriction, through the input/output interface based on user history information related to the user authentication information restriction.

12. The method of claim 9, wherein the outputting of the user authentication information restriction through the input/output interface comprises outputting at least one no-touch zone.

13. The method of claim 9, wherein the user input characteristics comprise at least one of processing unit information of the input user authentication information, difference information between the input user authentication information and the user authentication information restriction, or status or ambient environment information of the electronic device maintained by a user while the user authentication information is being input.

14. The method of claim 13, wherein the determining of the user input characteristics comprises determining the user input characteristics through comparison with user history information related to the user input characteristics to the electronic device.

15. The method of claim 9,
wherein the user authentication information restriction comprises a plurality of restrictions, and
wherein the user authentication information restriction updated based on the determined user input characteristics comprises at least one restriction updated from among the plurality of restrictions.

16. The method of claim 12, wherein the user authentication information restriction updated based on the determined user input characteristics comprises the at least one no-touch zone, a location of which is changed and updated based on the determined user input characteristics.

17. A computer program product comprising a recording medium having stored therein a program for executing a method of controlling an electronic device, the method comprising:
outputting a user authentication information restriction through an input/output interface;
determining user input characteristics, based on user authentication information input based on the user authentication information restriction; and
outputting, through the input/output interface, the user authentication information restriction updated based on the determined user input characteristics.
